(19) United States
(12) Patent Application Publication
(10) Pub. No.: US 2018/0204006 A1
(43) Pub. Date: Jul. 19, 2018

(54) FAST AUTHENTICATION OF CODE IN A LOW-POWER SYSTEM

(71) Applicant: QUALCOMM TECHNOLOGIES INTERNATIONAL, LTD., Cambridge (GB)

(72) Inventors: David BARR, Karmiel (IL); Shengtao SHEN, Shanghai (CN); Shahar GINO, Haifa (IL); Wei WANG, Shanghai (CN)

(21) Appl. No.: 15/742,213

(22) PCT Filed: Jul. 23, 2015
(86) PCT No.: PCT/CN2015/084961

§ 371 Date: Jan. 5, 2018

(51) Int. Cl. G06F 21/57

(52) U.S. Cl. CPC G06F 21/572; H04L 9/3247; G06F 21/575

(57) ABSTRACT

The invention relates to a system comprising a non-volatile memory device configured to contain executable code; and a logic device comprising an internal memory and a processor configured to execute the code contained in the non-volatile memory device, the internal memory being located in a first always-on power domain of the logic device, wherein the system is configured to check whether the internal memory contains a code digest Hc, obtain the executable code from the non-volatile memory device, compute a code digest Hc″ of the executable code, and, if the code digest Hc and the code digest Hc″ are identical, execute the executable code. The invention also relates to a corresponding method.

### TECHNICAL FIELD

Embodiments of the invention described herein relate to a system and method for fast authentication of code in a low-power system.

### BACKGROUND

Secure systems require authenticated-boot, a process that authenticates that the code executed by the system is provided by an authorized entity and has not been tampered with. This is usually accomplished by the authorized entity signing a digest (hash) of the code by encrypting the digest with its private key, using asymmetric public-key cryptography operations, for example RSA. Upon system boot, the system verifies the code by decrypting the signed digest with the signing entity's public key using asymmetric cryptography operations, re-computing the code digest, and comparing it to the authenticated digest. Asymmetric (public-key) cryptographic operations are very complex and take a long time. For micro-controller based applications where the signed code is usually relatively small, processing time for the authentication is dominated by the asymmetric cryptography operations. This is further exacerbated by the fact that MCUs often have limited processing power and, in low power systems, a limited operating frequency.

Low-power systems often rely on Non-Volatile Memory (NVM) to store code since the power supply to such memories can be switched off during extremely low-power modes (“hibernation”), thus eliminating the significant leakage current required to maintain a volatile memory. For cost reasons (silicon area, and expensive manufacturing processes for on-die NVM), external NVM, or Flash memory, is often used for code storage, and code is often executed directly from the external Flash memory (eXecute In Place, or XIP). Upon exiting the low-power hibernation mode in such a system, the processor needs to re-authenticate the code contained in the external Flash memory, as it could have been tampered with or replaced during hibernation while the external Flash memory power supply was switched off.

When such a secure MCU-based system is required to provide a fast response upon exit from hibernation, the time required to perform the asymmetric cryptography can be prohibitive. While hardware public-key arithmetic (PKA) accelerators can be used to accelerate the decryption, even such an acceleration would often not reduce the calculation time sufficiently, besides using additional silicon area and adding to the overall power consumption of the device.

Another issue typically encountered in this context is that the public part of the signing key-pair which is required in decrypting and verifying the signed digest is often stored in a one-time-programmable (OTP) memory. Access to such OTP memories, however, is generally slow and may require activation of significant system resources.

### SUMMARY OF EMBODIMENTS OF THE INVENTION

According to a first aspect of embodiments of the present invention, there is provided a system comprising a non-volatile memory device configured to contain executable code; and a logic device comprising an internal memory and a processor configured to execute the code contained in the non-volatile memory device, the internal memory being located in an always-on power domain of the logic device, wherein the system is configured to check whether the internal memory contains a code digest Hc, obtain the executable code from the non-volatile memory device, compute a code digest Hc″ of the executable code, and, if the code digest Hc and the code digest Hc″ are identical, execute the executable code from the non-volatile memory device.

The non-volatile memory device may be an external memory device, such as an external Flash memory device. Executing the executable code may imply that the executable code is executed directly from the (external) non-volatile memory, i.e., without copying the code to, e.g., an internal SRAM first. This concept is often referred to as ‘execute in place’, XIP.

The code digest Hc may be a pre-authenticated code digest. Pre-authenticating the code digest helps shorten the time required for (re-)authentication of the code. Pre-authentication of the code digest may, for example, be effected in response to a power-on boot reset thereby shortening the time required for a subsequent re-authentication of the code digest in response to a non-power-on boot reset. A power-on boot reset may, for instance, result from a (re-)connection of the system's power supply, whereas a non-power-on boot reset may arise during a “wake-up” of the system from a low-power/standby/hibernation mode.

The internal memory may be a write-once-by-software memory. Alternatively, the internal memory may a write-once-by-hardware/write-once-by-software memory.

The system may further comprise a one-time-programmable memory OTP and a hardware OTP copy engine, wherein the hardware OTP copy engine is configured to copy the contents of the one-time-programmable memory OTP to the internal memory.

The one-time-programmable memory OTP may contain a hash Hbk of a public part bkpub of a key-pair.

The system may be further configured to retrieve a signature S from the non-volatile memory device, obtain a code digest Hc′ from the digital signature, retrieve the executable code from the non-volatile memory device, compute the code digest Hc, compare the code digest Hc with the code digest Hc′ and, if the code digest Hc and the code digest Hc′ are identical, store this pre-authenticated code digest in the internal memory.

Obtaining the code digest Hc′ from the digital signature may comprise the step of decrypting the digital signature using the public part bkpub of a key-pair.

The system may be configured to retrieve a hash Hbk of bkpub, retrieve bkpub from the non-volatile memory device, compute a hash Hbk′ of bkpub, wherein Hbk′=H(bkpub), compare Hbk with Hbk′, and, if Hbk and Hbk′ are identical, determining that a valid signing key was used.

According to a second aspect of embodiments of the present invention there is provided a method comprising the following steps:
Providing a non-volatile memory device containing executable code and a logic device comprising an internal memory in an always-on power domain and a processor configured to execute the code contained in the non-volatile memory device;
Checking whether the internal memory contains a code digest Hc;
If the internal memory contains Hc, retrieving the executable code from the non-volatile memory device and computing a code digest Hc″ of the executable code;
Comparing the code digest Hc with the code digest Hc″;
If the code digest Hc and the code digest Hc″ are identical, executing the executable code.

The method may be initiated in response to a non-power-on reset. The non-volatile memory device may be an external memory device, such as an external Flash memory device. Executing the executable code may imply that the executable code is executed directly from the (external) non-volatile memory, i.e., without copying the code to, e.g., an internal SRAM first (XIP, see above).

The method may further comprise the steps of pre-authenticating the code digest Hc and storing the pre-authenticated code digest Hc in the internal memory. The steps of pre-authenticating the code digest Hc and storing the pre-authenticated code digest Hc in the internal memory may be carried out in response to a power-on reset.

The steps of pre-authenticating the code digest Hc and storing the pre-authenticated code digest Hc in the internal memory may, in turn, comprise the steps of
Retrieving a digital signature S from the non-volatile memory;
Obtaining a code digest Hc′ from the digital signature;
Retrieving the executable code from the non-volatile memory device and computing the code digest Hc;
Comparing the code digest Hc with the code digest Hc′;
If the code digest Hc and the code digest Hc′ are identical, storing the pre-authenticated code digest in the internal memory.

Obtaining the code digest Hc′ from the digital signature may comprise the step of decrypting the digital signature using the public part bkpub of a key-pair.

The method may further comprise the steps of
Retrieving a hash Hbk of bkpub;
Retrieving bkpub from the non-volatile memory device;
Computing a hash Hbk′ of bkpub, wherein Hbk′=H(bkpub);
Comparing Hbk with Hbk′;
If Hbk and Hbk′ are identical, determining that a valid signing key was used.

The step of retrieving a hash Hbk of bkpub may comprise the step of copying Hbk by hardware from a one-time-programmable memory to the internal memory.

The step of checking whether the internal memory contains a (pre-authenticated) code digest Hc may comprise the step of checking whether the internal memory has been actively written by software. This step may, for instance, comprise the step of reading out a particular memory location of the memory 124 which provides an indication for whether the internal memory 124 has been written by software or not. Alternatively or in addition thereto, this step may comprise a check of whether there is a non-zero value in at least one of the memory bits. In case the step of retrieving a hash Hbk of bkpub comprises the step of copying Hbk by hardware from a one-time-programmable memory to the internal memory, the step of checking whether the internal memory has been written by software may comprise a check of whether there is a non-zero value in at least one of the memory bits in the part of the memory not used for Hbk.

In case the step of checking whether the internal memory contains a (pre-authenticated) code digest Hc fails (i.e., there is no code digest Hc), the method may cause the steps of pre-authenticating the code digest Hc and storing the pre-authenticated code digest Hc in the internal memory.

### BRIEF DESCRIPTION OF THE FIGURES

Embodiments of the invention will now be described by way of example only, in which:

FIG. 1 shows a system according to an embodiment of the invention;

FIG. 2 shows a memory device used in an embodiment of the invention;

FIG. 3 shows a method according to an embodiment of the invention; and

FIG. 4 shows additional method steps according to an embodiment of the invention.

### DETAILED DESCRIPTION OF EMBODIMENTS OF THE INVENTION

The following description is presented to enable any person skilled in the art to make and use the invention, and is provided in the context of a particular application. Various modifications to the disclosed embodiments will be readily apparent to those skilled in the art. The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

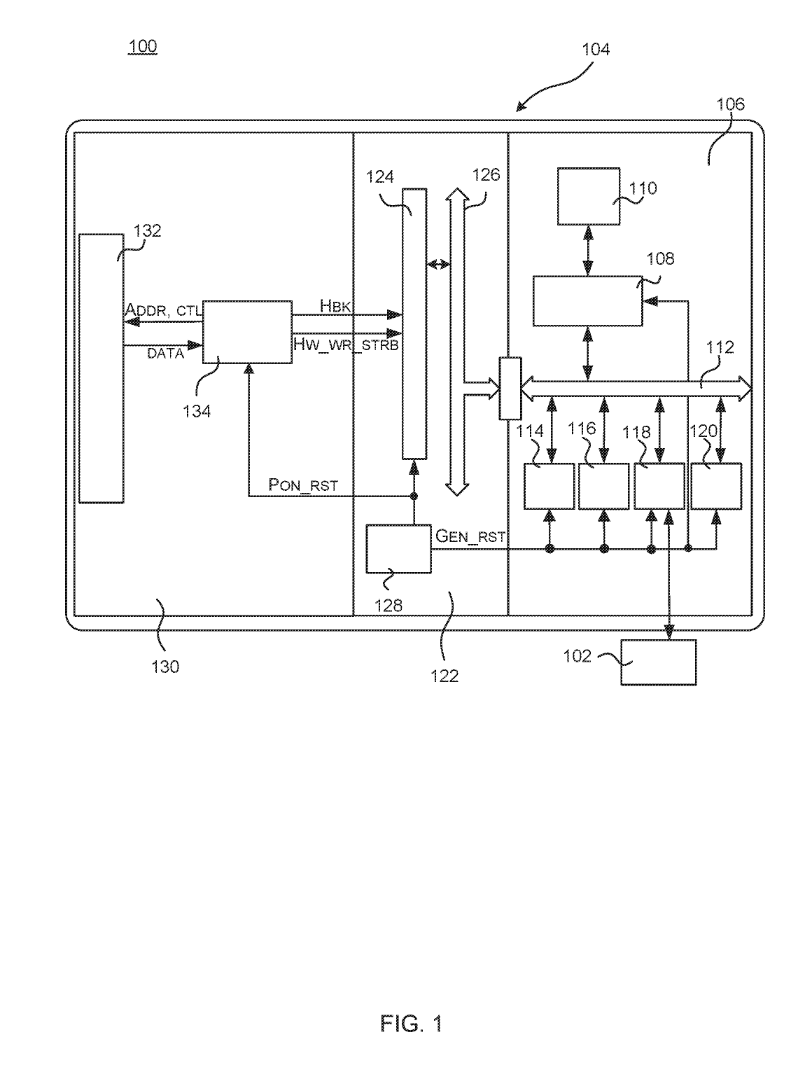

FIG. 1 shows a system 100 according to an embodiment of the invention. The system 100 comprises a non-volatile memory device 102 and a logic device 104.

The non-volatile memory device 102 is operatively coupled to the logic device 104. The non-volatile memory device 102 may be an external memory containing directly executable code (XIP). Alternatively, the non-volatile memory device 102 may use any other known non-volatile memory technology and/or may form an integral part of the logic device 104.

The logic device 104 comprises a first power domain 106 which, in turn, comprises a processor 108 (typically a microcontroller, MCU) with a volatile memory 110 coupled by means of a bus 112 to a Hash engine 114, a DMA engine 116 (optional), a XIP-(eXecute In Place-)interface/controller 118 through which the processor 108 is, in turn, coupled to the non-volatile memory device 102, and a read-only-memory ROM 120 containing trusted firmware. The first power domain 106 can be operated in normal mode and at least one low-power mode (‘hibernation’) to enable the system 100 to reduce power consumption in response to the number and complexity of tasks to be executed.

The Hash engine 114 is a hardware unit that implements a hash function with a 256-bit output, typically, but not necessarily, SHA-1 or SHA-2. To this end, either the processor 108 copies code from the non-volatile memory device 102 to the HASH engine 114, thus calculating the hash function H(code), or it can configure the DMA engine 116 to perform the copy.

The logic device 104 further comprises a second power domain 122 comprising an internal memory 124 coupled to the bus 112 by means of a bus 126 and further comprising a power management unit 128. The internal memory 124 is a secure special-function storage register of 256 bits but may of course be implemented in other ways and sizes as well. The second power domain 122 is an ‘always-on’ power domain which receives power for as long as the system 100 is connected to its power supply (not shown). The internal memory 124 may be a write-once-by-hardware and write-once-by-software secure storage memory. Alternatively, the internal memory 124 may be a write-once-by-software memory.

The power management unit 128 is configured to provide a power-on reset (shown as pon_rst) to the internal memory 124 that is separate from other resets (collectively shown as gen_rst). In the embodiment shown in FIG. 1, the power management unit 128 does not provide any reset to the internal memory 124 other than the power-on reset. Specifically, the power management unit 128 does not provide a non-power-on reset to the internal memory 124.

The logic device 104 further comprises a third power domain 130 comprising a one-time-programmable (OTP) memory 132 and an OTP copy engine 134 (bootstrap copy). The OTP memory 132 should have at least 128 bits. In the following exemplary embodiment, it is assumed that the OTP memory 132 has 256 bits, but this is just an example and the OTP memory 132 may have more or fewer bits than that. In fact, any hash function could be used, including ones with digests larger than 256 bits. For example, the SHA-2 family consists of six hash functions with digests that are 224, 256, 384 or 512 bits long.

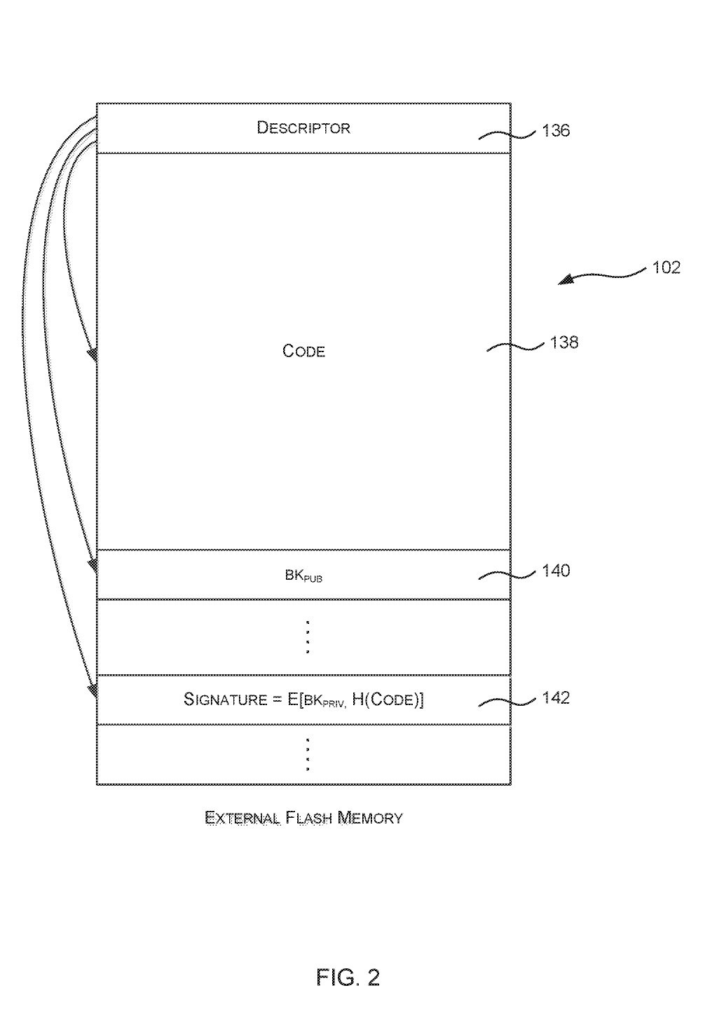

The contents of the non-volatile memory device 102 are now described in connection with FIG. 2. The non-volatile memory device 102 contains a descriptor field 136 which points to an executable code 138, to the public part of a signing entity's key-pair (usually provided as part of a certificate), bk_{pub} 140, as well as the signature of the code, E[bkₚᵣᵢᵥ, H(code)] 142, which is the code digest H(code) of the code 138 encrypted with the private part of the signing entity's key-pair, bkₚᵣᵢᵥ, where E[⋅,⋅] is the encryption operation of the chosen public-key cryptography scheme and H is a hash function.

The OTP memory 132 contains Hbk, a hash of the public part of the signing key-pair bk_{pub} 140, wherein the hash may be truncated, wherein Hbk=H(bk_{pub})[127:0]. This is introduced to the system during manufacturing, and cannot be changed. The system may contain several Hbk's, with an index (also in OTP) to indicate the first valid Hbk, which is to be used. This allows invalidating a signing key-pair, but requires in-field burning of the OTP. Alternatively, a full (non-truncated) 256-bit Hbk could be used, but the truncated Hbk saves OTP resources. While the OTP memory 132 is shown in FIG. 1 as belonging to the third power domain 130, it can be in any power domain that is active during power-on boot, as will become clearer from the description of the operation of the system 100 during power-on boot and non-power-on boot below. The Hbk may be contained in the boot ROM of the processor 108, but in this case several Hbk's will be required as described above with an index in the OTP memory 132. When the last Hbk is invalidated, a new ROM version will be required.

As will be described in detail below, systems according to the invention such as the one shown in FIG. 1 are configured to perform a full code authentication upon initial power-on reset. Once this has been done, the system can perform a fast code authentication when booting after waking up from a low-power hibernation mode. While the two flows are described separately, an actual implementation would of course combine the flows.

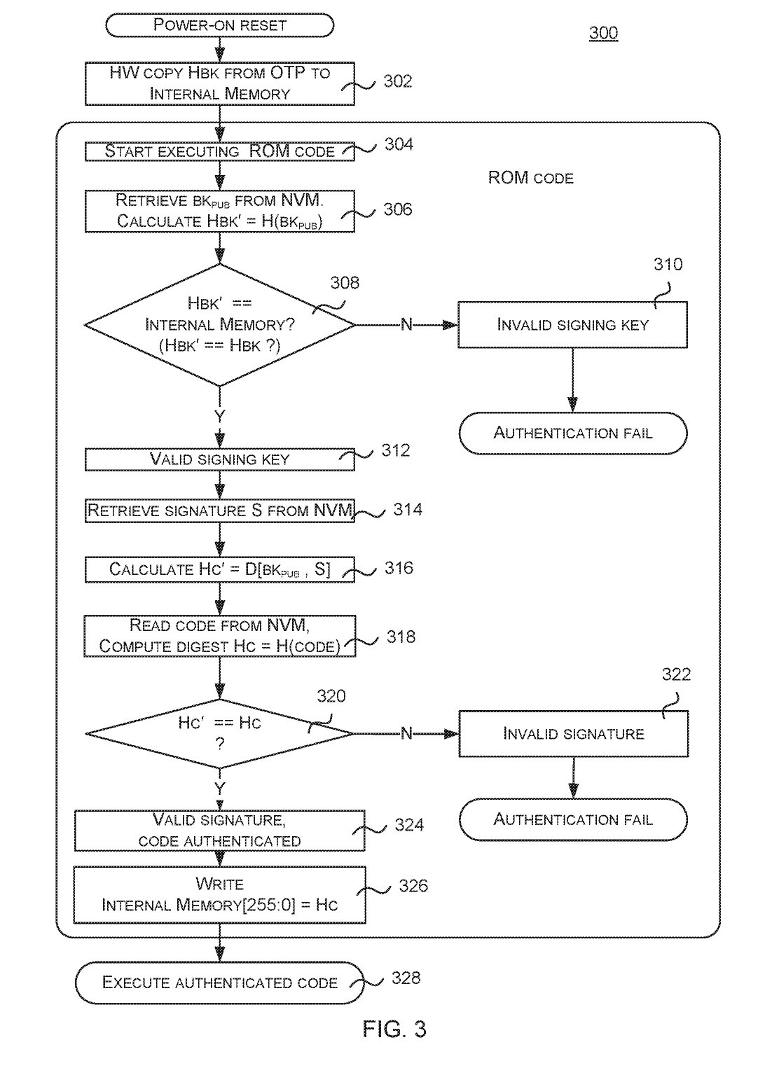

The initial boot flow 300 that occurs upon power-on reset is shown in FIG. 3. A full power-on reset condition occurs only when the power supply (such as the vehicle battery in case the system 100 is an automotive infotainment system) is connected for the first time or re-connected at a later stage. Otherwise the system is in active mode or in one of at least one low-power modes, including hibernation, even when the ignition key is removed.

In response to a power-on reset the system performs a (hardware) copy of a (truncated) hash Hbk of the public part of the signing key-pair bkpub 140 from the OTP memory 132 to, e.g., the first 128 bits of the internal memory 124 by means of OTP copy engine 134 (step 302). Once this operation has occurred, the internal memory 124 cannot be changed by hardware until the next power-on reset. If Hbk's are stored in e.g. ROM 120 rather than in the OTP memory 132, the hardware copy of Hbk to the internal memory 124 according to step 302 is not required. In that case the internal memory 124 will be write-once-by-software and the write-once-by-hardware property is not required.

Storing a hash Hbk or a truncated hash Hbk[127:0] instead of the entire public key bk_{pub} conserves OTP memory and allows changing the (e.g. RSA) key size without changing hardware. Alternatively, the entire public key bk_{pub} could just be stored in the OTP memory 132 which would, however, require a substantially larger memory.

Next, in step 304, the system 100 and specifically the processor 108 starts executing trusted code, typically in the form of immutable firmware in the ROM 120. In step 306, the public part of the signing entity's key-pair bk_{pub} 140 is retrieved from the non-volatile memory device 102 and a ‘fresh’ hash Hbk′ of bk_{pub} is calculated, i.e., Hbk′=H(bk_{pub}). In the subsequent step 308, a comparison is made between Hbk′ and Hbk.

If the two hash functions do not agree, the system 100 determines in step 310 that an invalid signing key was used and the authentication has failed. If the two hash function results are identical, the system 100 determines in step 312 that a valid signing key was used and moves on to step 314 by retrieving the signature S 142 from the non-volatile memory device 102. In step 316, a digest Hc′ is calculated by decrypting the signature S 142 with the public part of the signing key-pair bkpub 140 the validity of which has been checked in step 308, i.e., Hc′=D[bk_{pub}, S]. The cryptographic operations involved in step 316 are very complex and typically take a long time (often >500 ms).

In the next step 318, the code 138 is read from the non-volatile memory 102 and a ‘fresh’ digest Hc of the code is computed, i.e., Hc=H(code). Depending on the outcome of the comparison between Hc′ and Hc in step 320, the signature S 140 is either determined to be invalid (outcome=N; step 322) or valid (outcome=Y; step 324).

Step 324 implies that the executable code 138 has been authenticated. As a result, the confirmed code digest Hc (or Hc′ in case this is more convenient) is written, in step 326, to the internal memory 124 in the second ‘always-on’ power domain 122 of the system 100. In this example, the code digest Hc is a full (non-truncated) 256-bit hash and therefore occupies the entire internal memory 124 (i.e., bits 0 to 255). This also implies that the hash Hbk written to the first 128 bits of the internal memory 124 ‘by hardware’ in step 302 are overwritten ‘by software’ in step 326. More specifically, the internal memory 124 is written by trusted firmware in the ROM during the processor boot in step 326 and cannot thereafter be changed by any other software (running on the processor 108 or elsewhere in the system 100) until the next power-on reset. The contents of the internal memory 124 are not changed during any low-power mode, including hibernation.

The system 100 then moves on to executing the authenticated code 138 directly from the non-volatile memory device 102 (step 328).

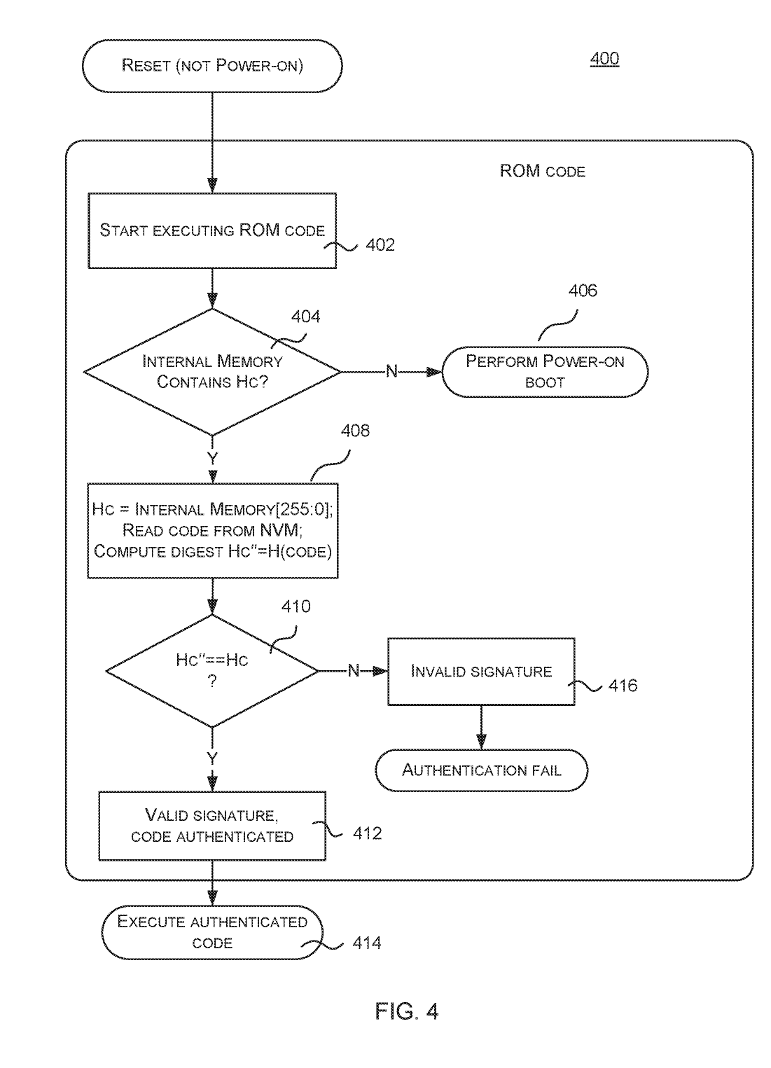

A non-power-on reset flow 400 is shown in FIG. 4. In response to a non-power-on reset the system 100 starts executing ROM code in step 402.

In the next step 404, it is determined whether the internal memory 124 contains a code digest Hc. This may be done by checking whether the internal memory 124 has been actively written by software or not and may, for instance, include the step of reading out a particular bit which provides an indication for whether the internal memory 124 has been written by software or not. In addition or alternatively, this may include the step of checking whether at least one bit in the part of the internal memory 124 not used for Hbk has a non-zero value. In the above example this would imply a check of whether at least one of the bits of the ‘upper’ 128 bits has a non-zero value. Step 404 may, however, comprise other and/or additional checks.

If it turns out that the internal memory 124 does not contain a code digest Hc, the system 100 causes a power-on boot in step 406, i.e., initiates the flow shown in FIG. 3 and thus a full authentication to ensure that a pre-authenticated code digest Hc is written to the internal memory 124 by software.

If the internal memory 124 is found to contain a code digest Hc, the process proceeds from step 406 to step 408.

In step 408, the code digest Hc is retrieved by reading out the content of the internal memory 124. The executable code 138 is then read from the non-volatile memory 102 and a ‘fresh’ digest Hc″ of the executable code 138 is computed.

In the next step 410, a comparison is made between Hc and Hc″. If the two digests are identical, it is determined, in step 412, that the signature is valid and that the code has been authenticated. As a result, the authenticated code can be executed by the system 100 in step 414.

If the two digests are not identical, the method proceeds from step 410 to step 416 according to which the system 100 determines that the signature is invalid in which case the authentication has failed and the code 138 is not executed.

The action to be taken upon an authentication failure, this is application and/or system dependent. In an automotive context, for instance, some systems may try to boot from a different copy of the boot image, assuming that the authentication failure may be due to boot media corruption rather than a malicious attack (“reliable boot”), or have another system re-write the boot media image. However, once it is determined that boot has failed, the system should go to the lowest possible power state, since the system may be powered by a vehicle battery when the engine is switched off.

One important difference between the flows 300 and 400 shown in FIGS. 3 and 4, respectively, is that step 316 is not required in flow 400. The only significant computation in the non-power-on boot shown in FIG. 4 is step 408 which essentially corresponds to step 318 in FIG. 3. In other words, the internal memory 124 in the second ‘always-on’ power domain 122 is configured to maintain a pre-authenticated code digest, thus shortening re-authentication and the associated power consumption. Moreover, since the internal memory 124 is re-used for both public boot-key digest Hbk and for the pre-authenticated code digest Hc, a further reduction in power consumption is achievable.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A system comprising:
a non-volatile memory device configured to contain executable code; and
a logic device comprising an internal memory and a processor configured to execute the code contained in the non-volatile memory device, the internal memory being located in an always-on power domain of the logic device,
wherein the system is configured to check whether the internal memory contains a code digest Hc, obtain the executable code from the non-volatile memory device, compute a code digest Hc″ of the executable code, and, if the code digest Hc and the code digest Hc″ are identical, execute the executable code from the non-volatile memory device.

2. The system of claim 1, wherein the code digest Hc is a pre-authenticated code digest.

3. The system of claim 1, wherein the internal memory is a write-once-by-software memory.

4. The system of claim 1, wherein the internal memory is a write-once-by-hardware/write-once-by-software memory.

5. The system of claim 1, further comprising a one-time-programmable memory OTP and a hardware OTP copy engine, wherein the hardware OTP copy engine is configured to copy the contents of the one-time-programmable memory OTP to the internal memory.

6. The system of claim 5, wherein the one-time-programmable memory OTP contains a hash Hbk of a public part bk_{pub} of a key-pair.

7. The system of claim 1, being further configured to retrieve a signature S from the non-volatile memory device, obtain a code digest Hc′ from the digital signature, retrieve the executable code from the non-volatile memory device, compute the code digest Hc, compare the code digest Hc with the code digest Hc′ and, if the code digest Hc and the code digest Hc′ are identical, store this pre-authenticated code digest in the internal memory.

8. The system of claim 7, wherein obtaining the code digest Hc′ from the digital signature comprises the step of decrypting the digital signature using the public part bk_{pub} of a key-pair.

9. The system of claim 8, being further configured to retrieve a hash Hbk of bk_{pub}, retrieve bk_{pub} from the non-volatile memory device, compute a hash Hbk′ of bk_{pub}, wherein Hbk′=H(bk_{pub}), compare Hbk with Hbk′, and, if Hbk and Hbk′ are identical, determining that a valid signing key was used.

10. A method comprising the following steps:
Providing a non-volatile memory device containing executable code and a logic device comprising an internal memory in an always-on power domain and a processor configured to execute the code contained in the non-volatile memory device;
Checking whether the internal memory contains a code digest Hc;
If the internal memory contains Hc, retrieving the executable code from the non-volatile memory device and computing a code digest Hc″ of the executable code;
Comparing the code digest Hc with the code digest Hc″;
If the code digest Hc and the code digest Hc″ are identical, executing the executable code.

11. The method of claim 10, further comprising the steps of pre-authenticating the code digest Hc and storing the pre-authenticated code digest Hc in the internal memory.

12. The method of claim 11, wherein the steps of pre-authenticating the code digest Hc and storing the pre-authenticated code digest Hc in the internal memory comprise
Retrieving a digital signature S from the non-volatile memory;
Obtaining a code digest Hc′ from the digital signature;
Retrieving the executable code from the non-volatile memory device and computing the code digest Hc;
Comparing the code digest Hc with the code digest Hc′;
If the code digest Hc and the code digest Hc′ are identical, storing the pre-authenticated code digest in the internal memory.

13. The method of claim 12, wherein obtaining the code digest Hc′ from the digital signature comprises the step of decrypting the digital signature using the public part bk_{pub} of a key-pair.

14. The method of claim 13, further comprising the steps of
Retrieving a hash Hbk of bk_{pub};
Retrieving bk_{pub} from the non-volatile memory device;
Computing a hash Hbk′ of bk_{pub}, wherein Hbk′=H(bk_{pub});
Comparing Hbk with Hbk′;
If Hbk and Hbk′ are identical, determining that a valid signing key was used.

15. The method of claim 14, wherein the step of retrieving a hash Hbk of bk_{pub} comprises the step of copying Hbk by hardware from a one-time-programmable memory to the internal memory.

16. The method of claim 10, wherein the step of checking whether the internal memory contains a code digest Hc comprises checking whether the internal memory has been actively written by software.

17. The method of claim 10, wherein, in case the internal memory does not contain a code digest Hc, the method causes the steps of pre-authenticating a code digest and storing the pre-authenticated code digest in the internal memory.
